(19) United States
(12) Patent Application Publication
(10) Pub. No.: US 2009/0018044 A1
(43) Pub. Date: Jan. 15, 2009

(54) AEROSOL CLEANER WITH CORROSION-INHIBITING ACTION

(75) Inventors: Michael Dreja, Neuss (DE); Daniela Poethow, Krefeld (DE)

Correspondence Address: Ratner Prestia, Suite 301, 1235 Westlakes Drive, Berwyn, PA, 19312, US

(73) Assignee: Henkel AG & Co. KGaA, Duesseldorf (DE)

(21) Appl. No.: 12/166,353

(22) Filed: Jul. 2, 2008

Related U.S. Application Data
(63) Continuation of application No. PCT/EP2006/012282, filed on Dec. 20, 2006.

(30) Foreign Application Priority Data
Jan. 2, 2006 (DE) 10 2006 000 691.7

(51) Int. Cl. C11D 3/04; C23F 11/18

(52) U.S. Cl. 510/279; 252/387

(57) ABSTRACT

A nanoparticulate colloidal silica can be used as a corrosion inhibitor in aqueous compositions which are stored in aerosol spray cans. In particular, it is possible to formulate spray cleaners for carpets, said cleaners comprising a nanoparticulate colloidal silica as a corrosion inhibitor as being used in a process for cleaning carpets.

### CROSS-REFERENCE TO RELATED APPLICATIONS

This application is a continuation under 35 U.S.C. §§ 120 and 365(c) of International Application PCT/EP2006/012282, filed on Dec. 20, 2006. This application also claims priority under 35 U.S.C. § 119 of DE 10 2006 000 691.7 filed on Jan. 2, 2006. The disclosures of PCT/EP2006/012282 and DE 10 2006 000 691.7 are hereby incorporated by reference in their entirety.

### BACKGROUND OF THE INVENTION

The subject of this application is a spray cleaner for carpets for spraying from aerosol containers, which comprises nano-particulate colloidal silica as the corrosion inhibitor.

The use of aerosol containers (spray cans) for spraying cleaning agents is very common nowadays. The use of cleaners in aerosol form offers numerous advantages. Thus, inter alia the cleaning agent is uniformly dispersed on the application surface, furthermore it can be dosed easily and in a well-controlled manner, in addition the consumption of cleansing agent is lower. Moreover, a suitable formulation enables a cleaning foam to be produced. Aerosol cleaning foams are particularly advantageously employed when active substances should be particularly uniformly and finely dispersed or should be optically recognizable after application for subsequent dispersion or working in. An example of this is carpet cleaning, for which aerosol foams are widely used because a uniform spray application, working in and drying of the foam as well as a subsequent removal by suction are required.

However, a problem with the aerosol packaging is illustrated by its danger of corrosion. Aerosol containers are generally made of aluminum or steel sheet. An interior coating can help to avoid corrosion. The interior coating is admittedly complex to apply and makes the manufacturing process more expensive. Steel sheets are mostly provided with a thin coating of tin, which possesses a higher barrier to corrosion against cleansing formulations (particularly against chloride ions, inter alia from surfactants, as well as against acids and bases) than the pure steel sheet. However, the danger exists that the tin plating is not applied absolutely uniformly. In this case pitting corrosion can occur at the imperfections. If the layer of tin is no longer intact, then an electrochemical cell and a corrosion current flow are formed at the point of contact of both metals, with the result that continuous destruction of the steel begins, which can lead to pinhole formation. On these grounds, corrosion inhibitors are added to cleansing formulations that are stored in aerosol packaging.

Conventional corrosion inhibitors that are added in amounts of 0.01 to 5 wt. % are for example alkali metal nitrites and alkali metal benzoates, borates, alkanolamines and alkanolamides, amine compounds like morpholine, amides or also silicones. However, nitrites and borates, due to their chemical irritating effect, are outdated as active substances; amines and amides, on the other hand, are often not sufficiently effective to prevent corrosion of the aerosol container over the long term.

### DESCRIPTION OF THE INVENTION

Consequently, the question is posed for an effective, irritant-free corrosion inhibitor that is compatible with current aerosol cleansing formulations. It has now been surprisingly found that the addition of colloidal, particulate silica with particle sizes of 2 to 50 nm, preferably 5 to 20 nm, especially 8 to 12 nm, to cleansing formulations leads to the long-lasting inhibition of corrosion of tin-plated steel sheet aerosol containers, and significantly surpasses the effect of previously known corrosion inhibitors. This is not limited to carpet cleansers, but can also be advantageously utilized for further aerosol formulations based on water, for example air fresheners, impregnants, furniture care products, general purpose cleansers, deodorants, hair sprays, glass cleansers, sprayable butter etc.

Accordingly, the subject matter of this invention is the use of a nano-particulate colloidal silica as a corrosion inhibitor in aqueous compositions that are stored in aerosol spray cans.

Preferably however, this corrosion inhibitor is employed in carpet cleansers. Accordingly, a further subject matter of this invention is a spray cleanser for carpets, sprayed from aerosol containers, which comprises nano-particulate colloidal silica as the corrosion inhibitor.

The carpet cleanser according to the invention can be filled into customary aerosol containers. In this regard, containers of tin-plated steel sheet are particularly preferably employed. Further subject matter of this invention is accordingly a product made of a spray cleanser for carpets and an aerosol container made of tin-plated steel sheet.

The carpet cleaner is employed in a carpet cleaning process, in which the cleaner is sprayed uniformly onto the carpet to be cleaned, and optionally worked in by means of a brush or another suitable cleaning aid, dried and subsequently removed from the carpet with a vacuum cleaner.

Accordingly, a further subject matter of this invention is a process for cleaning carpets, consisting of the steps, of spraying on an inventive cleanser from an aerosol container, optionally working it in, drying and removing by suction.

In the context of the present invention, fatty acids or fatty alcohols or their derivatives—when not otherwise specified—represent branched or unbranched carboxylic acids or alcohols or their derivatives containing 6 to 22 carbon atoms. Esters, due to their vegetal basis as well as being based on renewable raw materials, are particularly preferred on ecological grounds, without however the inventive teaching being limited to them. In particular, the oxo-alcohols or their derivatives, which are obtained, for example, by Roelen oxo synthesis, can also be employed.

In the following, whenever alkaline earth metals are named as counter ions for monovalent anions, then that means, of course, that the alkaline earth metal is present only in half the amount of the anion i.e. sufficient to equalize the charge.

Substances that also serve as ingredients of cosmetics are hereafter, where appropriate, named in accordance with the International Nomenclature of Cosmetic Ingredients (INCI). Chemical compounds carry an INCI name in English, vegetal ingredients are listed exclusively according to Linne in Latin. Common names such as “water”, “honey” or “sea salt” are also given in Latin. The INCI names are to be found in the International Cosmetic Ingredient Dictionary and Handbook, 7th Edition (1997), published by The Cosmetic, Toiletry and Fragrance Association (CTFA), 1101, 17^{th} Street NW, Suite 300, Washington, D.C. 20036, U.S. A., which comprises more than 9000 INCI names as well as more than 37 000 trade names and technical names including the associated distributors from more than 31 countries. The International Cosmetic Ingredient Dictionary and Handbook classifies the ingredients into one or more chemical classes, for example “Polymeric Ethers”, and into one or more functions, for example “Surfactants—Cleansing agents”, which are again mentioned in more detail. Reference to these will also be made below, as appropriate.

The indication CAS means that the following series of numbers relates to a name from the Chemical Abstracts Service.

Unless otherwise explicitly stated, the stated amounts refer to weight percent (wt. %) of the total agent. In this regard, these percentage amounts refer to the actives contents.

### Corrosion Inhibitors

A colloidal nano-particulate silica, especially a colloidal silica sol, is used as the corrosion inhibitor in aqueous compositions that are stored in aerosol spray cans. Colloidal nano-particulate silica-sols in the context of this invention are stable dispersions of amorphous particulate silicon dioxide SiO₂ having particle sizes in the range 1 to 100 nm. In this regard, the particle sizes are preferably in the range 2 to 50 nm, particularly preferably 5 to 20 nm, especially 8 to 12 nm. An example of a silica-sol that in the context of this invention is suitable for addition is the silica-sol having a particle size of 9 nm, which is available under the trade name Bindzil® 30/360 from Akzo. Further suitable silica-sols are Bindzil® 15/500, 30/220, 40/200 (Akzo), Nyacol® 215, 830, 1430, 2034DI as well as Nyacol® DP5820, DP5480, DP5540 etc. (Nyacol Products), Levasil® 100/30, 10° F./30, 100S/30, 200/30, 200F/30, 300F/30, VP 4038, VP 4055 (H.C. Starck/Bayer) or also CAB-O—SPERSE® PG 001, PG 002 (aqueous dispersions of CAB-O-SIL®, Cabot), Quartron PL-1, PL-3 (FusoChemical Co.), Kostrosol 0830, 1030, 1430 (Chemiewerk Bad Köstritz). The employed silica sols can also be surface modified silica, treated with sodium aluminate (alumina-modified silica).

### Surfactants

The carpet cleaner advantageously comprises one or more surfactants, preferably those that are selected from the group that contains anionic surfactants, non-ionic surfactants and mixtures of the same, in amounts of 0.1 to 10 wt. %, preferably 1 to 5 wt. %.

Suitable anionic surfactants are preferably C₈-C₁₈ alkylbenzene sulfonates, particularly containing about 12 carbon atoms in the alkyl moiety, C₈-C₂₀ alkane sulfonates, C₁₀-C₂₀ alkyl sulfates (fatty alcohol sulfates), C₈-C₁₈ alkyl polyglycol ether sulfates (fatty alcohol ether sulfates) containing 2 to 10 ethylene oxide (EO) and/or propylene oxide (PO) units in the ether moiety as well as sulfosuccinic acid mono- and -di-C₈-C₁₈ alkyl esters. In addition, C₈-C₁₈ α-olefin sulfonates, sulfonated C₈-C₁₈ fatty acids, in particular dodecylbenzene sulfonate, C₈-C₂₂ carboxylic acid amide ether sulfates, C₈-C₁₈ alkyl polyglycol ether carboxylates, C₈-C₁₈ N-acyl taurides, C₈-C₁₈ N-sarcosinates and C₈-C₁₈ alkyl isethionates or their mixtures can also be used.

The anionic surfactants are preferably added as sodium salts, but can also be comprised as other alkali metal or alkaline earth metal salts, for example magnesium salts, as well as in the form of ammonium or mono, di, tri or tetraalkylammonium salts, in the case of the sulfonates and alkyl sulfonates also in the form of their corresponding acids, e.g. dodecylbenzene sulfonic acid.

Examples of this type of surfactant are sodium lauryl sulfate, sodium lauryl ether sulfate containing 2 EO, sodium sec-alkane sulfonate containing about 15 carbon atoms, sodium lauroyl sarcosinate or also sodium dioctyl sulfosuccinate.

As the non-ionic surfactants, principally C₈-C₁₈ alcohol polyglycol ethers, i.e. ethoxylated and/or propoxylated alcohols containing 8 to 18 carbon atoms in the alkyl moiety and 2 to 15 ethylene oxide (EO) and/or propylene oxide units (PO), C₈-C₁₈ carboxylic acid polyglycol esters containing 2 to 15 EO, for example tallow fatty acid+6-EO-ester, ethoxylated fatty acid amides containing 12 to 18 carbon atoms in the fatty acid moiety and 2 to 8 EO, long chain amine oxides containing 14 to 20 carbon atoms and long chain alkyl polyglycosides containing 8 to 14 carbon atoms in the alkyl moiety and 1 to 3 glycoside units. Examples of this type of surfactants are oleyl-cetyl alcohol containing 5 EO, nonylphenol containing 10 EO, lauric acid diethanolamide, cocosalkyldmethylamine oxide or lauryidimethylamine oxide and cocosalkyl polyglucoside containing on average 1.4 glucose units. End capped C₈-C₁₈ alkyl alcohol polyglycol ethers can also be employed, i.e. compounds in which the normally free OH group of the C₈-C₁₈ alkyl alcohol polyglycol ether is etherified. Nitrogen-containing surfactants can be comprised as further surfactants, e.g. fatty acid polyhydroxyamides, for example glucamides, and ethoxylates of alkylamines, vicinal diols and/or carboxylic acid amides, which possess alkyl groups containing 10 to 22 carbon atoms, preferably 12 to 18 carbon atoms. The degree of ethoxylation of these compounds is generally between 1 and 20, preferably between 3 and 10. Ethanolamide derivatives of alkane acids containing 8 to 22 carbon atoms, preferably 12 to 16 carbon atoms, are preferred.

In a particularly preferred embodiment, the agent according to the invention comprises at least one amine oxide.

Besides the previously cited surfactant types, the agent according to the invention can also additionally comprise cationic surfactants and/or amphoteric surfactants.

Suitable amphoteric surfactants are, for example, betaines of the formula (R^{III})(R^{IV})(R^{V})N⁺CH₂COO⁻, in which, R^{III} means an alkyl group with 8 to 25, preferably 10 to 21 carbon atoms, optionally interrupted by heteroatoms or heteroatomic groups, and R^{IV} and R^{V} mean the same or different alkyl groups with 1 to 3 carbon atoms, in particular C₁₀-C₁₈ alkyldimethylcarboxymethyl betaine and C₁₁-C₁₇ alkylamidopropyldimethylcarboxymethyl betaine. The agents comprise amphoteric surfactants in amounts, based on the composition, of 0 to 10 wt. %.

Suitable cationic surfactants are inter alia the quaternary ammonium compounds of the Formula (R^{VI})(R^{VII})(R^{VIII})(R^{IX})N⁺X⁻, in which R^{VI} to R^{IX} stand for four identical or different alkyl groups, in particular two long and two short chain alkyl groups and X⁻ for an anion, especially a halide ion, for example didecyldimethyl-ammonium chloride, alkyl-benzyl-didecyl-ammonium chloride and their mixtures. The agents comprise cationic surfactants in amounts, based on the composition, of 0 to 10 wt. %.

In a particularly preferred embodiment, the carpet cleaner, is however free of cationic and amphoteric surfactants.

### Solvent

In addition, the carpet cleaner can preferably comprise one or more water-soluble and/or water-miscible organic solvents. Exemplary suitable solvents are saturated or unsaturated, preferably saturated, branched or unbranched C₁₋₂₀ hydrocarbons, preferably C₂₋₁₅ hydrocarbons, containing at least one hydroxyl group and optionally one or more ether functions C—O—C, i.e. oxygen atoms interrupting the chain of carbon atoms. Preferred solvents are the C₂₋₆ alkylene glycols and poly-C₂₋₃ alkylene glycol ethers—optionally etherified on one side with a C₁₋₆ alkanol—containing on average 1 to 9 identical or different, preferably identical alkylene glycol groups per molecule, as also the C₁₋₆ alcohols.

Exemplary solvents are the following compounds named according to INCI: Alcohol (Ethanol), Buteth-3, Butoxydiglycol, Butoxyisopropanol, Butoxypropanol, n-Butyl Alcohol, t-Butyl Alcohol, Butylene Glycol, Butyloctanol, Diethylene Glycol, Dimethoxydiglycol, Dimethyl Ether, Dipropylene Glycol, Ethoxydiglycol, Ethoxyethanol, Ethyl Hexanediol, Glycol, Hexanediol, 1,2,6-Hexanetriol, Hexyl Alcohol, Hexylene Glycol, Isobutoxypropanol, Isopentyldiol, 3-Methoxybutanol, Methoxydiglycol, Methoxyethanol, Methoxyisopropanol, Methoxymethylbutanol, Methoxy PEG-10, Methylal, Methyl Alcohol, Methyl Hexyl Ether, Methylpropanediol, Neopentyl Glycol, PEG-4, PEG-6, PEG-7, PEG-8, PEG-9, PEG-6 Methyl Ether, Pentylene Glycol, PPG-7, PPG-2-Buteth-3, PPG-2 Butyl Ether, PPG-3 Butyl Ether, PPG-2 Methyl Ether, PPG-3 Methyl Ether, PPG-2 Propyl Ether, Propanediol, Propyl Alcohol (n-Propanol), Propylene Glycol, Propylene Glycol Butyl Ether, Propylene Glycol Propyl Ether, Tetrahydrofurfuryl Alcohol, Trimethylhexanol. Among the glycols and glycol ethers, exemplary preferably employable solvents are butyl glycol (INCI Butoxy Ethanol, Ethylene Glycol Butyl Ether), diethylene glycol, dipropylene glycol or also propylene glycol; among the C₁₋₆ alcohols, preferably ethanol, n-propanol, iso-propanol (INCI Isopropyl Alcohol) or n-butanol are used, particularly ethanol. The agent according to the invention comprises Water-soluble and/or water-miscible organic solvents preferably in amounts of 0.01 to 10 wt. %, preferably 0.1 to 8 wt. %, particularly 1 to 6 wt. %.

Besides the previously cited ingredients, the agent according to the invention can comprise additional ingredients. These particularly include salts, polymers, builder components, pH adjusters, acids, bases, waxes, foam inhibitors, foam stabilizers, fragrances, preservatives, disinfectants, thickeners, bleaching agents, color transfer inhibitors, color conditioners, soil-release agents, soil repellents, enzymes, silicones, wetting agents, UV stabilizers, impregnating agents, odor eliminators, mite repellents, mosquito repellents, anti-allergy agents, antimicrobials, antibacterials, antistats as well as mixtures thereof.

### Salts

In addition, the carpet cleanser according to the invention can comprise one or more water-soluble, inorganic and/or organic salts.

Inorganic salts used according to the invention are preferably selected from the group containing colorless water-soluble halides, sulfates, sulfites, carbonates, hydrogen carbonates, nitrates, nitrites, phosphates and/or oxides of the alkali metals, of the alkaline earth metals, of aluminum and/or of transition metals; in addition, ammonium salts can be used.

In this regard, halides and sulfates of the alkali metals are particularly preferred; consequently the inorganic salt is preferably selected from the group containing sodium chloride, potassium chloride, sodium sulfate, potassium sulfate as well as their mixtures.

The organic salts that can be used according to the invention are in particular colorless water-soluble alkali metal, alkaline earth metal, ammonium, aluminum and/or transition metal salts of carboxylic acids. The salts are preferably selected from the group containing formate, acetate, propionate, citrate, malate, tartrate, succinate, malonate, oxalate, lactate as well as mixture of these.

### Polymers

The polymers that can be used in the agents according to the invention contain in particular those with soil-release or soil-repellent properties, in addition, however, also those, which can serve as thickeners, defoamers or anti-allergy agents for instance, as well as additional polymers that can usually be employed in cleansing agents.

Soil-release and soil-repellent polymers are, for example, polymers with perfluorinated side chains, homopolymers and copolymers of methacrylic acid, polyamines, particularly alkoxylated polyamines, N-vinyl polymers, for example polyvinyl pyrrolidone, polycarboxylates, particularly polyacrylates or acrylic acid-maleic acid copolymers, cellulose derivatives or copolymers of ethylene terephthalate. Polymeric thickeners are the polycarboxylates that as polyelectrolytes act as thickeners, preferably homopolymers and copolymers of acrylic acid, particularly acrylic acid copolymers such as acrylic acid-methacrylic acid copolymers, and the polysaccharides, particularly heteropolysaccharides, as well as conventional thickening polymers. Examples of polymeric thickeners are in particular polysaccharide gums such as Xanthane gum or guar gum but also polyacrylates. Polyethylene glycols are further advantageously useable polymers.

Polymer-surfactant mixtures can also be advantageously employed, such as those offered for sale by various manufacturers. Consequently, a preferred ingredient, for example, is the raw material Akypogene KTS (Kao), a mixture of a sodium lauryl ether carboxylate and ammonium polyacrylate, which is particularly well suited for the filling of aerosol cans. The polymer is absorbed onto the carpet fibers and consequently reduces the re-soiling tendency. Moreover, the polymer binds the added surfactant such that it becomes brittle and consequently can be more easily removed with the vacuum cleaner.

### Volatile Alkali; Bases

In addition, the inventive compositions can comprise volatile alkali. Ammonia and/or alkanolamines that can contain up to 9 carbon atoms in the molecule are used as the latter. The preferred alkanolamines are ethanolamines, and among these, monoethanolamine. In addition to this, the cleansing agents according to the invention can also comprise minor quantities of bases. Preferred bases are derived from the group of the hydroxides and carbonates of alkali metals and alkaline earth metals, particularly the alkali metal hydroxides, from which potassium hydroxide and principally sodium hydroxide being particularly preferred. Alkali or bases are principally used for adjusting a pH to between 8.5 and 10.5.

### Acids

Besides the volatile alkali, alkaline compositions can additionally comprise carboxylic acids. Suitable carboxylic acids are those containing up to 6 carbon atoms, wherein they can be mono-, di- or polycarboxylic acids. Suitable exemplary carboxylic acids are acetic acid, glycolic acid, lactic acid, citric acid, succinic acid, adipic acid, malic acid, tartaric acid and gluconic acid, of which acetic acid, citric acid and lactic acid are preferably used.

### Propellants

The cleansing agent preferably comprises one or more propellants, usually in an amount of 1 to 80 wt. %, preferably 1.5 to 30 wt. %, particularly 2 to 10 wt. %, particularly preferably 2.5 to 8 wt. %, above all 3 to 6 wt. %.

Propellants, according to the invention, are usually propellant gases, particularly liquefied or compressed gases. The choice depends on the product to be sprayed and the field of application. When using compressed gases such as nitrogen, carbon dioxide or nitrous oxide, which are generally insoluble in the liquid cleansing agent, the operating pressure is reduced with each actuation of the valve. Liquefied gases that are soluble in, or that themselves act as solvents for the cleansing agent, offer the advantage as propellants of a constant operating pressure and uniform distribution, because the propellant evaporates in air and then expands several hundred times in volume.

Accordingly, the following are suitable propellants (names according to INCI): Butane, Carbon Dioxide, Dimethyl Carbonate, Dimethyl Ether, Ethane, Hydrochlorofluorocarbon 22, Hydrochlorofluorocarbon 142b, Hydrofluorocarbon 152a, Hydrofluorocarbon 134a, Hydrofluorocarbon 227ea, Isobutane, Isopentane, Nitrogen, Nitrous Oxide, Pentane, Propane.

However, the use of chlorofluorocarbons (CFC) as propellants is preferably widely avoided and especially totally avoided due to their harmful effect on the ozone layer of the atmosphere that protects against harmful UV radiation.

Preferred propellants are liquefied gases. Liquefied gases are gases that can be transformed from the gaseous into the liquid state at mostly already low pressures and 20° C. However liquid gases are particularly understood to be the hydrocarbons propane, propene, butane, butene, isobutane (2-methylpropane), isobutene (2-methylpropene, isobutylene) and their mixtures, which occur as by products from distilling and cracking oil in oil refineries as well as in natural gas processing in gasoline separation.

The cleansing agent particularly preferably comprises one or a plurality of propellants selected from propane, butane and/or isobutane, especially propane and butane, most preferably propane, butane and isobutane. Preferred mixtures of propane, butane and isobutene comprise, based on the mixture, 23 to 28.5 wt. % propane and in total 71.5 to 77 wt. % butane and isobutane, especially 23 to 28.4 wt. % propane, 0.1 to 5 wt. % butane and 71.5 to 76.9 wt. % isobutane, for example 25 wt. % propane and in total 75 wt. % butane and isobutane. Butane and mixtures of propane and butane as well as propane, butane and isobutane are obtainable for example under the trade name Drivosol® from Oxeno (DE) or Degussa-Hüls (DE).

### Aerosol Containers

The agent according to the invention can be filled up into conventional aerosol containers made of aluminum or steel sheet, as are offered for sale by various manufacturers. However, aerosol containers of tin-plated steel sheet are particularly preferably employed.

### Cleaning Process

The agent according to the invention is used in a carpet cleaning process. For this the cleaning agent is first applied from an aerosol container by spraying onto the soiled surface. It is then optionally worked in with the help of a brush or another cleaning aid or substrate. The agent then dries out and is finally removed, together with the soiling, by means of a vacuum cleaner.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed or as needed to render such methods operative.

Changes in form and substitution of equivalents are contemplated as circumstances may suggest or render expedient. Although specific terms have been employed herein, such terms are intended in a descriptive sense and not for purposes of limitation.

### EXAMPLES

A formulation E1 according to the invention was prepared and filled into an aerosol container, whose corrosion resistance was then tested. The same procedure was carried out with two comparative formulations V1 and V2, which did not comprise colloidal silica. The compositions are presented in the following Table, wherein the quantities of the added raw materials are given in wt. %, based on the composition.

| Raw Material | E1 | V1 | V2 |
|---|---|---|---|
| Lauryldimethylamine oxide | 3.3 | 3.3 | 3.3 |
| Ethanol | 5 | 5 | 5 |
| Perfume | 0.15 | 0.15 | 0.15 |
| Colloidal Silica | 0.3 | — | — |
| Ether carboxylic acid/Acrylate mixture^{a} | 11 | 11 | — |
| Acrylic acid/Styrene Copolymer | — | — | 8.5 |
| Sodium Laurylsarcosinate | — | — | 1 |
| Distilled Water | ad 100 | ad 100 | ad 100 |
| pH (adjusted with NaOH) | 9.4 | 9.4 | 9.4 |

^{a}Mixture of the sodium salt of lauryl polyglycol ether carboxylic acid and acrylate copolymer, for example Akypogene KTS ® from Rhodia

The three formulations were filled into tin-plated steel cans (tin plate can d 65×240 NI 15 bar, content 600 ml) with propane/butane (Drivosol 3.5 bar) as the propellant and submitted to a storage test under controlled conditions (12 months, 20° C., 6 months 40° C.). The containers were opened after 3, 6 and 12 months and inspected for corrosion.

It was determined that the cans filled with the inventive formulation E1 exhibited no detinning or corrosion in the headroom, in the casing and in the bottom region. The cans were absolutely bright on the inside and did not show any damage caused by the contained cleaner.

In contrast, detinning and corrosion in the headroom as well as in the casing and bottom area were observed in the cans filled with the comparative formulation V1. Although the comparative formulation V2 did not lead to any corrosion in the headroom, the casing or bottom area, the cans exhibited a high level of detinning in the region in contact with the formulation.

What is claimed:

1. A method of inhibiting corrosion in aerosol spray cans storing aqueous compositions, comprising the steps of:
a. providing an aerosol spray can in need of corrosion inhibition;
b. filling the container with an aqueous composition comprising nanoparticulate colloidal silica.

2. The method of claim 1, wherein the aqueous composition comprises a carpet cleaner.

3. The method of claim 2, wherein the silica has a particle size of 2 nm to 50 nm.

4. The method of claim 2, wherein the carpet cleaner comprises one or more surfactants.

5. The method of claim 4, wherein the carpet cleaner comprises up to 10% by weight of the surfactants.

6. The method of claim 4, wherein the surfactant comprise an anionic surfactant, a non-ionic surfactant, or a mixture thereof.

7. The method of claim 2, wherein the carpet cleaner comprises one or more water soluble or water miscible solvents.

8. The method of claim 2, wherein the carpet cleaner comprises one or more propellants.

9. The method of claim 8, wherein the propellant comprises propane or butane or a mixture thereof.

10. An aerosol spray cleaner for carpets, comprising nanoparticulate colloidal silica as a corrosion inhibitor.

11. The spray cleaner of claim 10, wherein the silica has a particle size of 2 nm to 50 nm.

12. The spray cleaner of claim 10, comprising one or more surfactants.

13. The spray cleaner of claim 12, comprising 0.1% to 10% by weight of the surfactants.

14. The spray cleaner of claim 12, wherein the surfactants comprise an anionic, surfactant, a non-ionic surfactant or a mixture thereof.

15. The spray cleaner of claim 12, comprising an amine oxide.

16. The spray cleaner of claim 10, comprising one or more water soluble or water miscible solvents.

17. The spray cleaner of claim 10, comprising one or more propellants.

18. The spray cleaner of claim 17, wherein the propellant comprises propane, butane, or a mixture thereof.

19. The spray cleaner of claim 10, comprising one or more salts, polymers, builder components, pH adjusters, acids, bases, waxes, foam inhibitors, foam stabilizers, fragrances, preservatives, disinfectants, thickeners, bleaching agents, color transfer inhibitors, color conditioners, soil-release agents, soil repellents, enzymes, silicones, wetting agents, UV stabilizers, impregnating agents, odor eliminators, mite repellents, mosquito repellents, anti-allergy agents, antimicrobials, antibacterials, antistats, and mixtures thereof.

20. An aerosol spray cleaner for carpets, comprising an aerosol container formed of tin plated steel sheet, the container being filled with an aqueous composition comprising a surfactant, a propellant, and as a corrosion inhibitor, nanoparticulate colloidal silica.
